(19) United States
(12) Patent Application Publication
(10) Pub. No.: US 2013/0339201 A1
(43) Pub. Date: Dec. 19, 2013

(54) Fair Distribution Of Power Savings Benefit Among Customers In A Computing Cloud

(71) Applicant: International Business Machines Corporation, Armonk, NY (US)

(72) Inventors: Pradipta K. Banerjee, Bangalore (IN); Vaidyanathan Srinivasan, Bangalore (IN); Vijay K. Sukthankar, Bangalore (IN)

(21) Appl. No.: 13/774,233

(22) Filed: Feb. 22, 2013

Related U.S. Application Data
(63) Continuation of application No. 13/526,905, filed on Jun. 19, 2012.

(51) Int. Cl. G06Q 40/00

(52) U.S. Cl. CPC G06Q 40/10
USPC 705/30

(57) ABSTRACT

A technique for fairly distributing power savings benefits to virtual machines (VMs) provisioned to customers in a computing cloud. One or more VMs are provisioned on a target cloud host in response to resource requests from one or more customer devices. Host power savings on the target host are monitored. The host power savings are used as a variable component in determining per-customer cloud usage for accounting purposes. The host power savings may be reflected as power related cost savings in a generated cloud usage calculation result that may be distributed proportionately to the VMs based on VM size and utilization. VMs of relatively larger size and lower utilization may receive a higher percentage of the cost savings than VMs of relatively smaller size and higher utilization.

### BACKGROUND

1. Field

The present disclosure relates to cloud-based computing systems. More particularly, the disclosure concerns power management on cloud server hosts running virtual machines on behalf of customers.

2. Description of the Prior Art

By way of background, power management features in cloud server host hardware and subsequent exploitation at the operating system level enables significant cost savings due to efficiently managing server power consumption based on utilization. The lower the utilization, the higher the power savings. For a data center provider, cost savings due to power usage savings drive better ROI (Return On Investment) for a virtualized or cloud scenario. Currently, however, all such benefits are enjoyed by the provider only. Customers typically pay a fixed charge to the provider based on cloud resource usage. As far as known, current systems do not pass on the benefits of low power usage to the user. Applicants submit that this has at least two disadvantages. First, there is no significant motivation to select a cloud provider with more power efficient hardware and software that would contribute to reduction in energy utilization. Second, using power efficient technology may have a slight negative impact on the performance of workload SLAs (Service Level Agreements). In the absence of any benefit due to power savings being passed to customers, there is no motivation for the customers to choose energy efficient technology for even non-critical workloads.

It is to improvements in the field of cloud computing that the present disclosure is directed. In particular, applicants disclose a distribution mechanism to pass on the benefits accruing from data center power savings to customers, thus motivating customer selection of power efficient technology the reduction of computing-related energy demand.

### SUMMARY

A system, method and computer program product support fair distribution of power savings benefits to virtual machines (VMs) provisioned to customers in a computing cloud. According to an example embodiment, one or more VMs are provisioned on a target cloud host in response to resource requests from one or more customer devices. Host power savings on the target host are monitored. The host power savings are used as a variable component in determining per-customer cloud usage for accounting purposes.

According to further embodiments, the host power savings may be reflected as power related cost savings in a generated cloud usage calculation result. More particularly, the host power savings may be used to calculate metered cost savings that are distributed proportionately to the VMs. By way of example, the metered cost savings may be distributed to the VMs based on VM size and utilization. VMs of relatively larger size and lower utilization may receive a higher percentage of the cost savings than VMs of relatively smaller size and higher utilization. The VM size for a particular VM may be determined by a number of virtual CPUs (num_vcpus) provisioned to the VM on the target host as a fraction of a number of physical CPUs on the target host. The VM utilization may be determined by actual VM resource usage as a fraction of the total VM resource capacity averaged over a time period T.

In a specific embodiment, the cost savings may be distributed to the VMs based on the relationship:

$$Share for {VM}_{n} = \frac{( 1 - {U}_{n} ) * {S}_{n}}{{\sum }_{i = 1 to n} ( 1 - {U}_{i} ) * {S}_{i}} * {C}_{s}$$

where “Share for VM” is cost saving for a given VM, “U” is VM utilization, “S” is VM size, and “C” is cost savings realized on the target host.

### BRIEF DESCRIPTION OF THE DRAWINGS

The foregoing and other features and advantages will be apparent from the following more particular description of an example embodiment, as illustrated in the accompanying Drawings, in which:

FIG. 1 is a functional block diagram showing a physical view of an example cloud computing environment that may be constructed in accordance with the present disclosure;

FIG. 2 is a functional block diagram showing a logical view the cloud computing environment of FIG. 1 in which cloud hosts are provisioned with virtual machines for use by customers;

FIG. 3 is a functional block diagram showing an example cloud host following virtual machine provisioning;

FIG. 4 is a flow diagram showing example cost analyzer logic that may be implemented by a resource manager server in the cloud computing environment of FIG. 1;

FIG. 5 is a functional block diagram showing a machine apparatus that may be used to implement the resource manager server and various cloud hosts within the cloud computing environment of FIG. 1; and

FIG. 6 is a diagrammatic illustrate of example data storage media that may be used to store program instructions for implementing cost analyzer logic in the cloud computing environment of FIG. 1.

### DETAILED DESCRIPTION OF EXAMPLE EMBODIMENTS

### Introduction

In embodiments disclosed herein, a technique is proposed whereby power savings in a virtualized host running multiple virtual machines (hereinafter VMs) serve as a variable component in cloud usage for accounting purposes. For example, cost savings realized from reducing power consumption can be metered and distributed proportionately to each VM, with each VM getting a share based on its size and utilization. VMs with low utilization receive a higher percentage of the cost savings because they contribute more toward power reduction as compared to VMs with high utilization. In a case where two VMs have the same utilization but different sizes, the power savings contribution by the VM with higher size is more and the benefits will be passed on accordingly. The total share of the cost savings realized by a given cloud customer will be a summation of all the VM shares belonging to the customer. As an option, different power savings distribution rules may apply to VMs assigned to different quality of service pools. As a further option, if a cloud service provider wants to keep a fixed share of the power savings without distribution to the VMs, the fixed share can be adjusted against the total cost savings and the remaining net cost savings can be distributed among the VMs.

### Example Embodiments

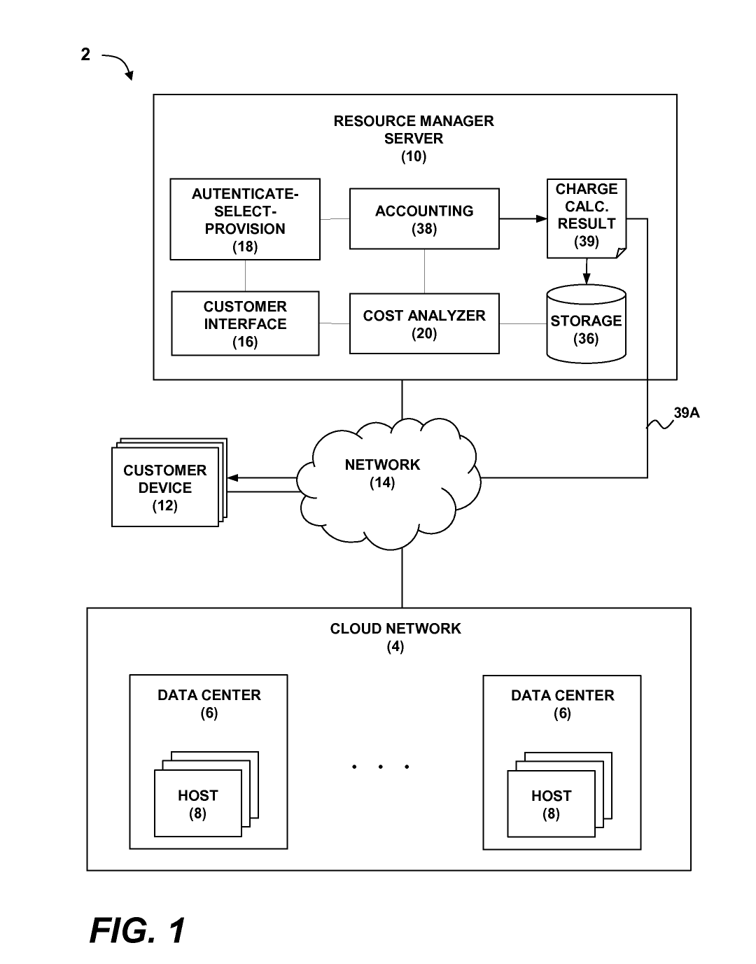

Turning now to the drawing figures, FIG. 1 illustrates physical resources in an example cloud computing environment 2 representing one possible embodiment that may be used to practice the subject matter disclosed herein. The cloud computing environment 2 includes a cloud network 4 that includes one or more cloud data centers 6, each comprising one or more physical server hosts 8. As is conventionally known, a resource manager server 10 may be provided to provision virtualized resources of the hosts 8 within the cloud network 4 in response to resource requests from customer devices 12. As is typical of cloud computing, each resource request from a customer device 12 may specify a desired level of computing power, such as some number of processors, a memory size, a storage capacity, a network capacity, and other resource requirements. Different quality of service levels may also be offered by the resource manager server 10, such that a customer device 12 may also specify a a suitable service level agreement (SLA). Based on the resource request, the resource manager server 10 will select one or more of the hosts 8 from which to provision one or more VMs on behalf of the requesting client device 12.

The resource manager server 10 may be located outside the cloud network 4 or may be disposed within it. FIG. 1 illustrates an embodiment in which the resource manager server 10 is outside the cloud network 4, and communicates with the data center(s) 6 via an external communication infrastructure, such as a suitable network 14. The resource manager server 10 may also communicate with the customer devices 12 via the network 14. If the resource manager server 10 were located within the cloud network 4, it could embodied in one (or more) of the hosts 8 or implemented in any other suitable manner.

The resource manager server 10 includes a conventional customer interface 16 that interacts with the customer devices 12 to support to cloud resource requests. The resource management server 10 further includes conventional authentication-selection-provisioning logic 18 whose purpose is to (1) authenticate a requesting customer device 12, (2) allow the customer device to select cloud computing resources, and (3) provision appropriate virtual resources on the hosts 8 within the cloud network 4. The foregoing components of the resource manager server are known in the art of cloud computing and will not be described in further detail herein in the interest of brevity. The core idea underlying the cloud concept is that the client devices 12 can request (and be allocated) resources from the cloud network 4 as a whole rather than from a specific host 8 within the cloud.

The resource manager server 10 also includes an additional component that is believed to be novel and not found within any prior art known to applicants. This component is identified in FIG. 1 as the cost analyzer 20. The purpose and function of the cost analyzer 20 is to provide a capability to utilize host power savings as a variable component in determining per-customer cloud usage for accounting purposes, such as by distributing related cost savings to VMs that are provisioned in response to cloud resource requests from the customer devices 12. For example, each VM may be allocated a share of cost savings based on its size and utilization.

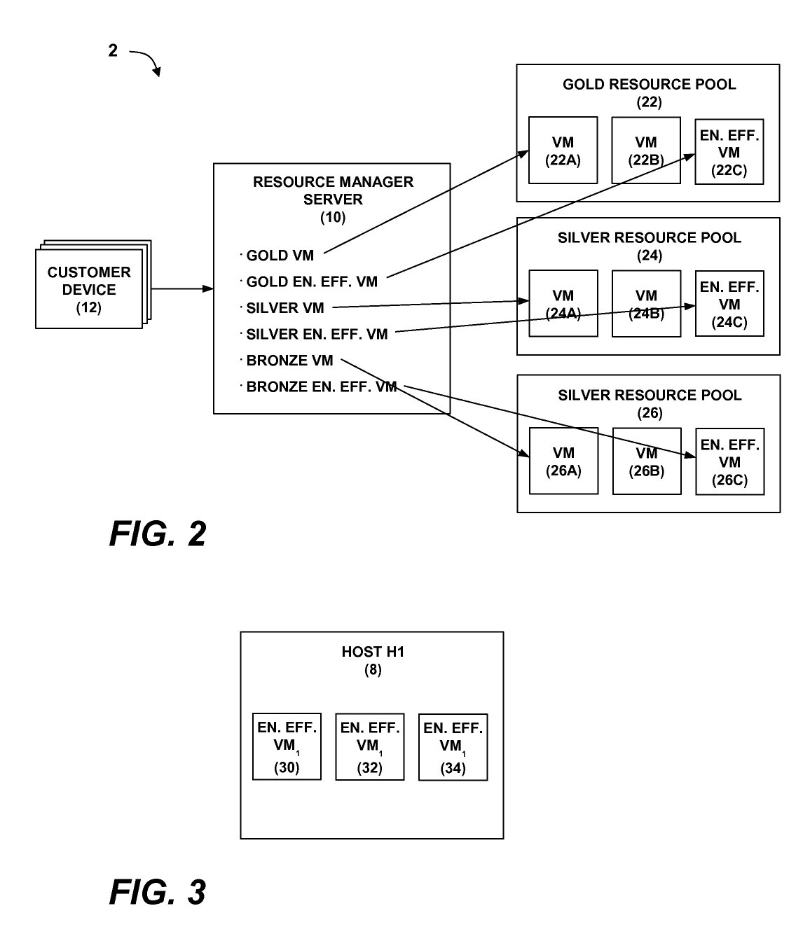

FIG. 2 will help illustrate this concept. It presents a logical view of the cloud computing environment 2 in which the resource manager server 10 has provisioned a number of VMs based on resource requests from the customer devices 12. The VMs are grouped into separate resource pools representing different quality of service levels, storage policies, energy policies, or hardware capabilities, namely, a “Gold” resource pool 22, a “Silver” resource pool 24, and a “Bronze resource pool 26. There are two normal VMs 22A/22B, 24A/24B and 26A/26B respectively disposed within each resource pool 22, 24 and 26. The resource pools 22, 24 and 26 also respectively include a energy efficient VM 22C, 24C and 26C. The energy efficient VMs 22C, 24C and 26C are VMs which have associated power-related cost savings allocated to them by the cost analyzer 20 (FIG. 1).

If desired, the ability to request regular VMs and energy efficient VMs in the various resource pools 22, 24 and 26 may be presented via the customer interface 16 (FIG. 1) to the customer devices 12 for display to human customer device users. If a user requests an energy efficient VM, any cost benefits associated with power consumption within a corresponding physical host 8 (FIG. 1) may be metered and distributed to the VM according to its size and utilization, or based on any other suitable distribution criteria. As stated in the Introduction section above, VMs with low utilization will receive a larger percentage of the cost savings because they contribute to more power savings as compared to Vms with high utilization. In the situation where two VMs have the same utilization but different sizes, the power savings contribution by the VM with larger size is more, and accordingly more of the cost savings benefits will be passed on. Following is an example calculation that may be used to determine a VM's cost saving share.

### Example Cost Savings Calculation

Referring now to FIG. 3, assume there is a cloud host 8 running three energy efficient VMs, namely VM₁ 30, VM₂ 32, and VM₃ 34. VM utilization may be expressed as the amount of actual VM resource usage as a fraction of the total VM resource capacity averaged over some period of time T. Such usage may be measured in terms of CPU load, memory utilization, usage of other host resources, or various combinations of resource usage. In the present example, the average VM utilization for VM₁ 30, VM₂ 32, and VM₃ 34 is determined to be U₁, U₂ and U₃, respectively, where (by way of example only) U may represent relative virtual CPU (vcpu) usage according to equation (1):

U=vcpu_usage/vcpu_capacity. (1):

Power consumption by the host 8 over the time period T is determined to be P_{H1}. The maximum power consumed by the host 8 when there are no energy savings is determined to be P_{maxH1}. The power savings over the time period T is Pₛ, and may be given by equation (2):

Pₛ=P_{maxH1}−P_{H1}. (2)

If power consumption on the host 8 has a cost per watt W_{c}, the power savings Pₛ will produce a corresponding metered cost savings Cₛ, and may be given by equation (3):

Cₛ=Pₛ*W_{c}. (3)

The respective sizes S₁, S₂ and S₃ of VM₁ 30, VM₂ 32, and VM₃ 34 may be determined from the number of virtual CPUs assigned to each VM as a fraction of the total number of physical CPUs on the host 8. The size S may thus be given by equation (4):

S=num_vcpus/num_pcpus. (4)

The cost saving share to be distributed to each of VM₁ 30, VM₂ 32, and VM₃ 34 may be determined from equation (5):

$$Share for {VM}_{n} = \frac{( 1 - {U}_{n} ) * {S}_{n}}{{\sum }_{i = 1 to n} ( 1 - {U}_{i} ) * {S}_{i}} * {C}_{s} \qquad ( 5 )$$

where n=3.

In this equation, the values (1−Uₙ) and (1−Uᵢ) give weight to low VM utilization, and the values Sₙ and Sᵢ give weight to VM size. The numerator of equation (1) represents such weightings for a single VM and the denominator of equation (2) represents a combined total of the weightings for all of the VMs. In a variation of the calculation of equation (5), a multiplier weighting factor could be applied based on the resource pool to which the VMs are assigned. For example, such weighting may be applied to favor VMs in resource pools that provide a higher quality of service level. In a further variation of equation (5), a cloud provider may want to keep a fixed share of the cost savings and only distribute a portion of such savings to the VMs.

Referring back to FIG. 1, the cost analyzer 20 in the resource manager server 10 may be implemented to perform the above calculations. In addition, the cost analyzer 20 may use appropriate VM monitoring methods to determine the operational information needed for equations (1) (VM utilization U₁, U₂, U₃ over time period T) and (2) (power savings Pₛ based on power consumption P_{H1} over time period T). For example, operating system or hypervisor statistics maintained by the host 8 may be used to track VM utilization. For power consumption, monitoring techniques such as those described in commonly-owned U.S. Patent Publication No. 2012/0030356 may be used, and may track information such as power distribution unit demand, cooling unit demand, etc. Equation (3) may be solved using a predetermined cost per watt value W_{c}, and equation (4) may be resolved from information available at VM provisioning time. Once equation (5) is used to determine the cost savings to be distributed to each VM, the cost savings information can be stored by the cost analyzer 20 in a database or storage component. The cost savings information will also be provided to an accounting program, system or function that calculates cloud usage charges to be paid by the business entities associated with the customer devices 12. The storage component and the accounting program, system or function may comprise part of the resource manager server (as shown by components 36 and 38 in FIG. 1) or they may reside separately therefrom. A cloud usage charge calculation result produced by the accounting component 36, which includes the host power savings as a variable component of a customer entity's cloud usage charge (e.g., a power savings credit), is shown by reference number 39. It may be stored temporarily or permanently in digital form in the storage component 36, and will also be communicated to the corresponding customer entity, either via the network 14 in electronic form to one of the customer devices 12 (see reference number 39A), or by other means. Each customer's cost savings will be based on the number of energy efficient VMs that the customer owns.

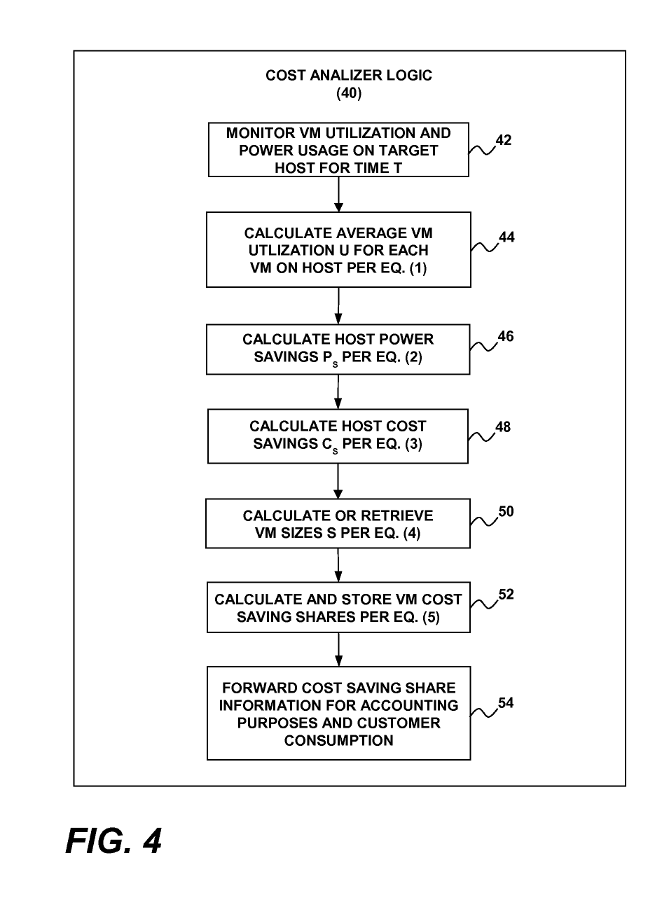

FIG. 4 is a flow diagram illustrating example cost analyzer logic 40 that may be implemented by the cost analyzer 20 to implement the above-described cost saving distributions. In block 42, the cost analyzer 20 monitors customer utilization of VM₁ 30, VM₂ 32, and VM₃ 34 and power usage on the host 8 for a designated time period T (e.g., one month). In block 44, the cost analyzer 20 uses the VM utilization information determined in block 42 to calculate (per equation (1)) the average VM utilization U₁, U₂ and U₃ for time period T for each of VM₁ 30, VM₂ 32, and VM₃ 34. In block 46, the cost analyzer 20 uses the host power usage information determined in block 42 to calculate (per equation (2)) the average host power savings Pₛ for time period T on the host 8. In block 48, the cost analyzer 20 calculates (per equation (3)) the average host cost savings Cₛ for time period T on the host 8. In block 50, the cost analyzer 20 calculates (per equation (4)) or retrieves the VM sizes S₁, S₂ and S₃, with the latter operation being performed if the VM sizes are static and calculated in advance at VM provisioning time. In block 52, the cost analyzer 20 calculates (per equation (5)) and stores the VM cost savings for each of VM₁ 30, VM₂ 32, and VM₃ 34. In block 54, the cost analyzer 20 forwards the per-VM cost saving share information for accounting purposes and customer consumption.

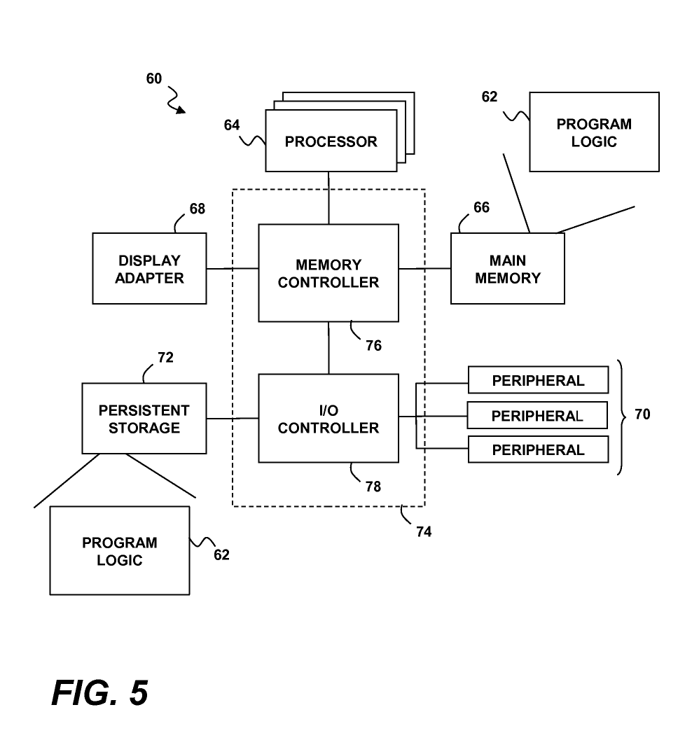

Turning now to FIG. 5, an example machine apparatus 60 is shown that may be used to implement the hardware and software resources of the resource manager server 10. The apparatus 60 executes program logic 62 that comprises the various functions of the resource manager server 10, including the cost analyzer 20 and its operational logic 40. According to one possible embodiment, the apparatus 60 may include one or more processors 64 that operate in conjunction with a main memory 66. The processors 64 may comprise general purpose processors or they may be custom-designed to support special purpose operations. The memory 66 may be implemented using any type of computer readable storage media capable of storing program instructions and data utilized by the processors 64 during instruction processing operations. Such media are typically referred to as primary storage. Examples include, but are not limited to, static or dynamic random-access memory, semiconductor read-only memory, or combinations thereof. The processors 64 and the memory 66 may be situated within a single computing node (e.g., as part of a single-node SMP system) or they may be distributed over plural nodes (e.g., as in a distributed NUMA system, a cluster, a cloud, etc.). Although not shown, conventional cache memories may be respectively associated with the processors 64 to buffer the program logic 62 stored in the main memory 66.

Additional components of the apparatus 60 may include a display adapter 68 (e.g., a graphics card) for generating visual output information (e.g., text and/or graphics) to a display device (not shown), and various peripheral devices 70 that may include a keyboard or keypad input device, a pointer input device, a network interface card (NIC), a USB bus controller, a SCSI disk controller, etc. A persistent storage device 72 may also be provided. The persistent storage device 72 may be implemented using many different types of data storage hardware, including but not limited to magnetic or optical disk storage, solid state drive storage, flash drive storage, tape backup storage, or combinations thereof. A bus or other communications infrastructure 74, which may include a memory controller hub or chip 76 (e.g., a northbridge) and an I/O (input/output) controller hub or chip 78 (e.g., a southbridge), may be used to interconnect the foregoing elements. It should be understood that the foregoing description is for purposes of illustration only, and that other components and arrangements may also be used to configure the apparatus 60.

The apparatus 60 may be implemented as a client or server machine. In either case, the program logic 62 may be implemented in software, firmware or a combination thereof, and possibly with some operations being performed by dedicated hardware logic. If implemented in software, the program logic 62 may be loaded from the persistent storage 72 into a portion of the main memory 66 that comprises RAM. If implemented in firmware, the program logic 72 could reside in a portion of the main memory 66 that comprises ROM, such as EPROM memory. The program logic 62 may comprise a collection of program instructions, possibly having entry and exit points, written in a suitable programming language. Such programming languages may include, but are not limited to, a high level procedural language such as C, a high level object oriented language such as C++, an interpreted language such as Java, BASIC, Perl, Python, or a lower level language such as assembly. The program instructions written in such languages may be compiled and/or interpreted and/or assembled (as the case may be) into machine language program instructions that are capable of execution on the processors 64. When the machine language program instructions are loaded into and executed by the processors 64, the resultant programmed apparatus 60 becomes a particular machine for practicing the subject matter described herein. The program instructions of the program logic 62 may be embodied in one or more modules, each of which may be compiled and linked into an executable program, installed in a dynamically linked library, or otherwise made ready for invocation and execution by the apparatus 60. The module(s) may be implemented to run with or without the support of an underlying operating system. They may be callable from other modules or from themselves, and/or may be invoked in response to detected events or interrupts.

As previously mentioned, some aspects of the program logic 62 could be implemented using dedicated logic hardware. Examples of such hardware would include connected logic units such as gates and flip-flops, and/or integrated devices, such as application specific integrated circuits (ASICs), field programmable gate arrays (FPGAs)), reconfigurable data path arrays (rDPAs) or other computing devices. The design, construction and operation of such devices is well known in the art, and will not be described further herein in the interest of brevity.

Additional instances of the machine apparatus 60 may be used to implement the hosts 8 in the cloud network 4, as could other types of computing systems. The cloud hosts 6 may be virtualized by configuring the machine apparatus with suitable virtualization logic to provide the VMs, such as a hypervisor or virtual machine monitor (VMM). As is known to persons skilled in the art, a conventional hypervisor is a low level software service that virtualizes the underlying hardware to provide a subset of the sharable hardware resources on behalf of each VM instance. The hypervisor may be implemented according to any of the VMM design concepts that have been in use since hypervisors were first developed in the late 1960s (taking into account the VM support capabilities of the underlying hardware). Well known examples of commercial hypervisors include the CP Control Program used in the IBM VM/370® mainframe products introduced by International Business Machines Corporation in 1972, the current zVM™ hypervisor used in the IBM System Z®/Z-Series® mainframe products, and the hypervisor used in the IBM Power Series® mid-range products. Note that reference to the foregoing commercial products is not intended to suggest that the subject matter disclosed herein is limited to mainframe or midrange computing environments. Quite the contrary, the disclosed subject matter could be implemented on any hardware platform having the ability to support virtual machine environments running concurrent workloads through the addition of appropriate hypervisor functionality. By way of example, this may include platforms based on the Intel x86 architecture.

The specific hypervisor examples mentioned above are designed to support VMs that each include a full operating system instance running user-level application software. This is known as platform-level virtualization, and such VMs are sometimes referred to as logical partitions or LPARs. The hypervisor may alternatively implement another type of virtualization known as operating system-level virtualization. Operating system-level virtualization uses a single operating system as a hypervisor to establish application-level VMs that are sometimes referred to as application containers. Examples of operating systems that have application container support capability include the IBM AIX® 6 operating system with WPAR (Workload PARtition) support, the IBM® Mciosys virtualization products, and Linux® operating system kernels built in accordance with the OpenVZ project, the VServer project, or the Free VPS project. These operating systems have the ability to selectively allocate physical and logical resources to their VMs. Such resource allocations may include CPUs, data storage resources, I/O (Input/Output) ports, network devices, etc. In the cloud network 4 of FIG. 1, either of the foregoing types of virtualization may be used.

Accordingly, a technique has been disclosed for fairly distributing power saving benefits to customers in a cloud computing environment. It will be appreciated that the foregoing concepts may be variously embodied in any of a machine implemented method, a computing system, and a computer program product. Example embodiments of a machine-implemented method have been described in connection with FIG. 2-4. Example embodiments of a computing system has been described in connection with FIGS. 1 and 5. With respect to a computer program product, digitally encoded program instructions may be stored on one or more data storage media for use in controlling a CPU or other instruction processing device to perform operations. The program instructions may be embodied as machine language code that is ready for loading and execution by the machine apparatus, or the program instructions may comprise a higher level language that can be compiled and/or interpreted and/or assembled into machine language. Example languages include, but are not limited to C, C++, Java, assembly, to name but a few. When implemented on a machine apparatus comprising a processor, the program instructions combine with the processor to provide a particular machine that operates analogously to specific logic circuits, which themselves could be used to implement the disclosed subject matter.

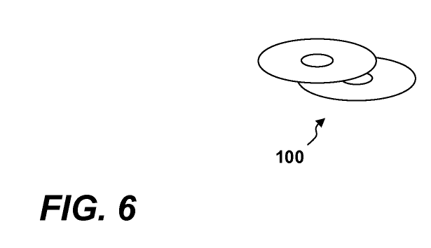

Example computer-readable storage media for storing digitally encoded program instructions are shown by reference numerals 66 (memory) and 72 (storage device) of the apparatus 60 in FIG. 5. A further example of computer-readable storage media that may be used to store the program instructions is shown by reference numeral 100 in FIG. 6. The storage media 100 are illustrated as being portable optical storage disks of the type that are conventionally used for commercial software sales, such as compact disk-read only memory (CD-ROM) disks, compact disk-read/write (CD-R/W) disks, and digital versatile disks (DVDs). Such storage media can store the program instructions either alone or in conjunction with an operating system or other software product that incorporates the required functionality. The storage media could also be provided by portable magnetic or electrical storage media (such as floppy disks, USB flash devices, etc.). The storage media may also be combined with drive systems (e.g. disk drives), or incorporated in a computing system (e.g., as random access memory (RAM), read-only memory (ROM) or other semiconductor or solid state memory). More broadly, the storage media could comprise any electronic, magnetic, optical, magneto-optical, infrared, semiconductor system or apparatus or device, or any other tangible entity representing a machine, manufacture or composition of matter that can contain, store, communicate, or transport the program instructions for use by or in connection with an instruction execution system, apparatus or device, such as a computer. For all of the above forms of storage media, when the program instructions are loaded into and executed by a computing system, the resultant programmed system becomes a particular machine for practicing embodiments of the method(s) and system(s) described herein.

Although various embodiments of the invention have been described, it should be apparent that many variations and alternative embodiments could be implemented in accordance with the present disclosure. It is understood, therefore, that the invention is not to be in any way limited except in accordance with the spirit of the appended claims and their equivalents.

1. A resource manager server method for fairly distributing power savings benefits to virtual machines (VMs) provisioned to customers in a computing cloud, comprising:
said resource manager server implementing program logic for provisioning one or more VMs on a target cloud host in response to resource requests received from one or more customer devices;
said resource manager server implementing program logic for monitoring host power savings on said target host; and
said resource manager server implementing program logic for using said host power savings as a variable component in determining per-customer cloud usage for accounting purposes.

2. The method of claim 1, wherein said host power savings are reflected as power related cost savings in a generated cloud usage calculation result.

3. The method of claim 1, wherein said host power savings are used to calculate metered cost savings that are distributed proportionately to said VMs.

4. The method of claim 3, wherein said metered cost savings are distributed to said VMs based on VM size and utilization.

5. The method of claim 4, wherein VMs of relatively larger size and lower utilization receive a higher percentage of said cost savings than VMs of relatively smaller size and higher utilization.

6. The method of claim 5, wherein said VM size for a particular VM is determined by a number of virtual CPUs (num vcpus) provisioned to said VM on said target host as a fraction of a number of physical CPUs on said target host, and wherein said VM utilization is determined by actual VM resource usage as a fraction of the total VM resource capacity averaged over a time period T.

7. The method of claim 6, wherein said cost savings are distributed to said VMs based on the relationship:
$$Share for {VM}_{n} = \frac{( 1 - {U}_{n} ) * {S}_{n}}{{\sum }_{i = 1 to n} ( 1 - {U}_{i} ) * {S}_{i}} * {C}_{s}$$
where “Share for VM” is cost saving for a given VM, “U” is VM utilization, “S” is VM size, and “C” is cost savings realized on said target host.

8-21. (canceled)
